(19) United States
(12) Patent Application Publication
(10) Pub. No.: US 2012/0135346 A1
(43) Pub. Date: May 31, 2012

(54) PROCESSES FOR PRODUCING POLYESTER LATEXES WITH BIO-BASED SOLVENTS

(75) Inventors: Guerino G. Sacripante, Oakville (CA); Shigang Qiu, Toronto (CA); Rina Carlini, Oakville (CA); Ke Zhou, Oakville (CA)

(73) Assignee: XEROX CORPORATION, Norwalk, CT (US)

(21) Appl. No.: 12/955,104

(22) Filed: Nov. 29, 2010

(51) Int. Cl. G03G 9/00

(52) U.S. Cl. 430/137.1

(57) ABSTRACT

A process for making a latex emulsion suitable for use in a toner composition includes contacting at least one polyester resin with a bio-based solvent to form a resin mixture, adding a neutralizing agent and deionized water to the resin mixture, removing the solvent from the formed latex, and recovering the emulsion. The solvent removed from the formed latex may be re-used, making the process very environmentally friendly.

### TECHNICAL FIELD

The present disclosure relates to processes for producing resin emulsions useful in producing toners. More specifically, more efficient solvent-based processes are provided for emulsifying polyester resins.

### BACKGROUND

Numerous processes are within the purview of those skilled in the art for the preparation of toners. Emulsion aggregation (EA) is one such method. Emulsion aggregation toners may be used in forming print and/or electrophotographic images. Emulsion aggregation techniques may involve the formation of a polymer emulsion by heating a monomer and undertaking a batch or semi-continuous emulsion polymerization, as disclosed in, for example, U.S. Pat. No. 5,853,943, the disclosure of which is hereby incorporated by reference in its entirety. Other examples of emulsion/aggregation/coalescing processes for the preparation of toners are illustrated in U.S. Pat. Nos. 6,730,450, 6,743,559, 6,756,176, 6,830,860, 7,029,817, and U.S. Patent Application Publication No. 2008/0107989, the disclosures of each of which are hereby incorporated by reference in their entirety.

Polyester EA ultra low melt (ULM) toners have been prepared utilizing amorphous and crystalline polyester resins as illustrated, for example, in U.S. Patent Application Publication No. 2008/0153027, the disclosure of which is hereby incorporated by reference in its entirety. The incorporation of these polyesters into the toner requires that they first be formulated into emulsions prepared by solvent containing batch processes, for example solvent flash emulsification and/or solvent-based phase inversion emulsification (PIE). In both cases, organic solvents, such as ketones or alcohols, have been used to dissolve the resins. These organic solvents, in some embodiments, are petroleum based and not environmentally friendly.

Methods which are more environmentally friendly for the production of resins remain desirable.

### SUMMARY

The present disclosure provides processes for making latex emulsions which, in turn, may be suitable for use in forming toner compositions. In embodiments, a process of the present disclosure includes contacting at least one polyester resin with at least one bio-based solvent to form a resin mixture; stirring the resin mixture; contacting the mixture with a neutralizing agent to form a neutralized mixture; contacting the neutralized mixture with de-ionized water to form an emulsion; and recovering the emulsion.

In other embodiments, a process of the present disclosure includes contacting at least one amorphous polyester resin and an optional crystalline resin with at least one bio-based solvent to form a resin mixture; heating the resin mixture to a temperature of from about 40° C. to about 90° C.; stirring the resin mixture; contacting the mixture with a neutralizing agent to form a neutralized mixture; contacting the neutralized mixture with de-ionized water to form an emulsion; distilling off a water/solvent distillate from the emulsion; and recovering the emulsion.

In yet other embodiments, a process of the present disclosure includes contacting at least one amorphous resin with at least one bio-based solvent such as 2-methyl-tetrahydrofuran, ethanol, 1,2-propane-diol, 1,3-propane-diol, 1,4-butane-diol, furfuryl alcohol, 2-butyl furan, difurylpropane, ethyl furfuryl ether, 2-bromo furan, 2-butyryl furan, 20-ethyl furan, 2-furaldehyde, 2-furfuryl alcohol, 2-methyl furan, tetrahydrofurfuryl alcohol, 2,5 dimethylfuran, and combinations thereof, to form a resin mixture; heating the resin mixture to a temperature of from about 40° C. to about 90° C.; stirring the resin mixture; contacting the mixture with a neutralizing agent to form a neutralized mixture; contacting the neutralized mixture with de-ionized water to form an emulsion; removing a water/solvent distillate from the emulsion; recovering the emulsion; and contacting the emulsion with a colorant, an optional wax, and a crystalline polyester resin to form toner particles.

### DETAILED DESCRIPTION

In embodiments, the present disclosure provides solvent based processes for forming polyester latexes which may be utilized in forming a toner. In accordance with the present disclosure, renewable bio-based solvents are used in the preparation of polyester latexes for EA ULM toner applications.

In embodiments, the addition of at least two solvents to a polyester resin allows the polyester resin to be emulsified in a solvent process. Solvents are added to permit the necessary reorientation of chain ends to stabilize and form particles which lead to the formation of stable latexes without surfactant.

Amorphous polyester latexes having particles with sizes from about 66 microns to about 200 microns may be prepared using these bio-based solvents, without any appreciable degradation in resin molecular weight and/or glass transition temperature (Tg).

The proposed approach replaces conventional petroleum-based solvents with renewable bio-based solvents, thereby minimizing reliance on fossil sources while producing EA toners with high print quality, and low energy and material usage, to minimize the impact of the preparation of these toners on the environment.

### Resins

Any resin may be utilized in forming a latex emulsion of the present disclosure. In embodiments, the resins may be an amorphous resin, a crystalline resin, and/or a combination thereof. In further embodiments, the resin may be a polyester resin, including the resins described in U.S. Pat. Nos. 6,593,049 and 6,756,176, the disclosures of each of which are hereby incorporated by reference in their entirety. Suitable resins may also include a mixture of an amorphous polyester resin and a crystalline polyester resin as described in U.S. Pat. No. 6,830,860, the disclosure of which is hereby incorporated by reference in its entirety.

In embodiments, the resin may be a polyester resin formed by reacting a diol with a diacid in the presence of an optional catalyst. For forming a crystalline polyester, suitable organic diols include aliphatic diols with from about 2 to about 36 carbon atoms, such as 1,2-ethanediol, 1,3-propanediol, 1,4-butanediol, 1,5-pentanediol, 2,2-dimethylpropane-1,3-diol, 1,6-hexanediol, 1,7-heptanediol, 1,8-octanediol, 1,9-nonanediol, 1,10-decanediol, 1,12-dodecanediol and the like including their structural isomers. The aliphatic diol may be, for example, selected in an amount from about 40 to about 60 mole percent, in embodiments from about 42 to about 55 mole percent, in embodiments from about 45 to about 53 mole percent, and a second diol can be selected in an amount from about 0 to about 10 mole percent, in embodiments from about 1 to about 4 mole percent of the resin.

Examples of organic diacids or diesters including vinyl diacids or vinyl diesters selected for the preparation of the crystalline resins include oxalic acid, succinic acid, glutaric acid, adipic acid, suberic acid, azelaic acid, sebacic acid, fumaric acid, dimethyl fumarate, dimethyl itaconate, cis, 1,4-diacetoxy-2-butene, diethyl fumarate, diethyl maleate, phthalic acid, isophthalic acid, terephthalic acid, naphthalene-2,6-dicarboxylic acid, naphthalene-2,7-dicarboxylic acid, cyclohexane dicarboxylic acid, malonic acid and mesaconic acid, a diester or anhydride thereof. The organic diacid may be selected in an amount of, for example, in embodiments from about 40 to about 60 mole percent, in embodiments from about 42 to about 52 mole percent, in embodiments from about 45 to about 50 mole percent, and a second diacid can be selected in an amount from about 0 to about 10 mole percent of the resin.

Examples of crystalline resins include polyesters, polyamides, polyimides, polyolefins, polyethylene, polybutylene, polyisobutyrate, ethylene-propylene copolymers, ethylene-vinyl acetate copolymers, polypropylene, mixtures thereof, and the like. Specific crystalline resins may be polyester based, such as poly(ethylene-adipate), poly(propylene-adipate), poly(butylene-adipate), poly(pentylene-adipate), poly(hexylene-adipate), poly(octylene-adipate), poly(ethylene-succinate), polypropylene-succinate), poly(butylene-succinate), poly(pentylene-succinate), poly(hexylene-succinate), poly(octylene-succinate), poly(ethylene-sebacate), poly(propylene-sebacate), poly(butylene-sebacate), poly(pentylene-sebacate), poly(hexylene-sebacate), poly(octylene-sebacate), poly(decylene-sebacate), poly(decylene-decanoate), poly(ethylene-decanoate), poly(ethylene dodecanoate), poly(nonylene-sebacate), poly(nonylene-decanoate), copoly(ethylene-fumarate)-copoly(ethylene-sebacate), copoly(ethylene-fumarate)-copoly(ethylene-decanoate), copoly(ethylene-fumarate)-copoly(ethylene-dodecanoate), copoly(2,2-dimethylpropane-1,3-diol-decanoate)-copoly(nonylene-decanoate), poly(octylene-adipate). Examples of polyamides include poly(ethylene-adipamide), poly(propylene-adipamide), poly(butylenes-adipamide), poly(pentylene-adipamide), poly(hexylene-adipamide), poly(octylene-adipamide), poly(ethylene-succinimide), and poly(propylene-sebecamide). Examples of polyimides include poly(ethylene-adipimide), poly(propylene-adipimide), poly(butylene-adipimide), poly(pentylene-adipimide), poly(hexylene-adipimide), poly(octylene-adipimide), poly(ethylene-succinimide), poly(propylene-succinimide), and poly(butylene-succinimide).

The crystalline resin may be present, for example, in an amount from about 1 to about 85 percent by weight of the toner components, in embodiments from about 5 to about 50 percent by weight of the toner components. The crystalline resin can possess various melting points of, for example, from about 30° C. to about 120° C., in embodiments from about 50° C. to about 90° C. The crystalline resin may have a number average molecular weight (Mₙ), as measured by gel permeation chromatography (GPC) of, for example, from about 1,000 to about 50,000, in embodiments from about 2,000 to about 25,000, and a weight average molecular weight (M_{W}) of, for example, from about 2,000 to about 100,000, in embodiments from about 3,000 to about 80,000, as determined by Gel Permeation Chromatography using polystyrene standards. The molecular weight distribution (M_{w}/Mₙ) of the crystalline resin may be, for example, from about 2 to about 6, in embodiments from about 3 to about 4.

Examples of diacids or diesters including vinyl diacids or vinyl diesters utilized for the preparation of amorphous polyesters include dicarboxylic acids or diesters such as terephthalic acid, phthalic acid, isophthalic acid, fumaric acid, trimellitic acid, dimethyl fumarate, dimethyl itaconate, cis, 1,4-diacetoxy-2-butene, diethyl fumarate, diethyl maleate, maleic acid, succinic acid, itaconic acid, succinic acid, succinic anhydride, dodecylsuccinic acid, dodecylsuccinic anhydride, glutaric acid, glutaric anhydride, adipic acid, pimelic acid, suberic acid, azelaic acid, dodecanediacid, dimethyl terephthalate, diethyl terephthalate, dimethylisophthalate, diethylisophthalate, dimethylphthalate, phthalic anhydride, diethylphthalate, dimethylsuccinate, dimethylfumarate, dimethylmaleate, dimethylglutarate, dimethyladipate, dimethyl dodecylsuccinate, and combinations thereof. The organic diacids or diesters may be present, for example, in an amount from about 40 to about 60 mole percent of the resin, in embodiments from about 42 to about 52 mole percent of the resin, in embodiments from about 45 to about 50 mole percent of the resin.

Examples of diols which may be utilized in generating the amorphous polyester include 1,2-propanediol, 1,3-propanediol, 1,2-butanediol, 1,3-butanediol, 1,4-butanediol, pentanediol, hexanediol, 2,2-dimethylpropanediol, 2,2,3-trimethylhexanediol, heptanediol, dodecanediol, bis(hydroxyethyl)-bisphenol A, bis(2-hydroxypropyl)-bisphenol A, 1,4-cyclohexanedimethanol, 1,3-cyclohexanedimethanol, xylenedimethanol, cyclohexanediol, diethylene glycol, bis(2-hydroxyethyl)oxide, dipropylene glycol, dibutylene, and combinations thereof. The amount of organic diols selected can vary, and may be present, for example, in an amount from about 40 to about 60 mole percent of the resin, in embodiments from about 42 to about 55 mole percent of the resin, in embodiments from about 45 to about 53 mole percent of the resin.

Polycondensation catalysts which may be utilized in forming either the crystalline or amorphous polyesters include tetraalkyl titanates, dialkyltin oxides such as dibutyltin oxide, tetraalkyltins such as dibutyltin dilaurate, and dialkyltin oxide hydroxides such as butyltin oxide hydroxide, aluminum alkoxides, alkyl zinc, dialkyl zinc, zinc oxide, stannous oxide, or combinations thereof. Such catalysts may be utilized in amounts of, for example, from about 0.01 mole percent to about 5 mole percent based on the starting diacid or diester used to generate the polyester resin.

In embodiments, as noted above, an unsaturated amorphous polyester resin may be utilized as a latex resin. Examples of such resins include those disclosed in U.S. Pat. No. 6,063,827, the disclosure of which is hereby incorporated by reference in its entirety. Exemplary unsaturated amorphous polyester resins include, but are not limited to, poly(propoxylated bisphenol co-fumarate), poly(ethoxylated bisphenol co-fumarate), poly(butyloxylated bisphenol co-fumarate), poly(co-propoxylated bisphenol co-ethoxylated bisphenol co-fumarate), poly(1,2-propylene fumarate), poly(propoxylated bisphenol co-maleate), poly(ethoxylated bisphenol co-maleate), poly(butyloxylated bisphenol co-maleate), poly(co-propoxylated bisphenol co-ethoxylated bisphenol co-maleate), poly(1,2-propylene maleate), poly(propoxylated bisphenol co-itaconate), poly(ethoxylated bisphenol co-itaconate), poly(butyloxylated bisphenol co-itaconate), poly(co-propoxylated bisphenol co-ethoxylated bisphenol co-itaconate), poly(1,2-propylene itaconate), and combinations thereof.

In embodiments, a suitable amorphous resin may include alkoxylated bisphenol A fumarate/terephthalate based polyesters and copolyester resins. In embodiments, a suitable amorphous polyester resin may be a copoly(propoxylated bisphenol A co-fumarate)-copoly(propoxylated bisphenol A co-terephthalate) resin having the following formula (I):

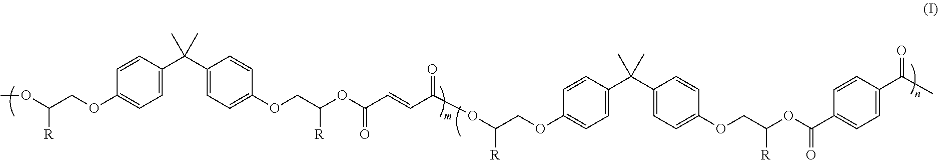

wherein R may be hydrogen or a methyl group, and m and n represent random units of the copolymer and m may be from about 2 to 10, and n may be from about 2 to 10. Examples of such resins and processes for their production include those disclosed in U.S. Pat. No. 6,063,827, the disclosure of which is hereby incorporated by reference in its entirety.

An example of a linear propoxylated bisphenol A fumarate resin which may be utilized as a latex resin is available under the trade name SPARII from Resana S/A Industrias Quimicas, Sao Paulo Brazil. Other propoxylated bisphenol A fumarate resins that may be utilized and are commercially available include GTUF and FPESL-2 from Kao Corporation, Japan, and EM181635 from Reichhold, Research Triangle Park, North Carolina, and the like.

In embodiments, the amorphous polyester resin may be a saturated or unsaturated amorphous polyester resin. Illustrative examples of saturated and unsaturated amorphous polyester resins selected for the process and particles of the present disclosure include any of the various amorphous polyesters, such as polyethylene-terephthalate, polypropylene-terephthalate, polybutylene-terephthalate, polypentylene-terephthalate, polyhexylene-terephthalate, polyheptadene-terephthalate, polyoctalene-terephthalate, polyethylene-isophthalate, polypropylene-isophthalate, polybutylene-isophthalate, polypentylene-isophthalate, polyhexylene-isophthalate, polyheptadene-isophthalate, polyoctalene-isophthalate, polyethylene-sebacate, polypropylene sebacate, polybutylene-sebacate, polyethylene-adipate, polypropylene-adipate, polybutylene-adipate, polypentylene-adipate, polyhexylene-adipate, polyheptadene-adipate, polyoctalene-adipate, polyethylene-glutarate, polypropylene-glutarate, polybutylene-glutarate, polypentylene-glutarate, polyhexylene-glutarate, polyheptadene-glutarate, polyoctalene-glutarate polyethylene-pimelate, polypropylene-pimelate, polybutylene-pimelate, polypentylene-pimelate, polyhexylene-pimelate, polyheptadene-pimelate, poly(ethoxylated bisphenol A-fumarate), poly(ethoxylated bisphenol A-succinate), poly(ethoxylated bisphenol A-adipate), poly(ethoxylated bisphenol A-glutarate), poly(ethoxylated bisphenol A-terephthalate), poly(ethoxylated bisphenol A-isophthalate), poly(ethoxylated bisphenol A-dodecenylsuccinate), poly(propoxylated bisphenol A-fumarate), poly(propoxylated bisphenol A-succinate), poly(propoxylated bisphenol A-adipate), poly(propoxylated bisphenol A-glutarate), poly(propoxylated bisphenol A-terephthalate), poly(propoxylated bisphenol A-isophthalate), poly(propoxylated bisphenol A-dodecenylsuccinate), SPAR (Dixie Chemicals), BECKOSOL (Reichhold Inc), ARAKOTE (Ciba-Geigy Corporation), HETRON (Ashland Chemical), PARAPLEX (Rohm & Haas), POLYLITE (Reichhold Inc), PLASTHALL (Rohm & Haas), CYGAL (American Cyanamide), ARMCO (Armco Composites), ARPOL (Ashland Chemical), CELANEX (Celanese Eng), RYNITE (DuPont), STYPOL (Freeman Chemical Corporation) and combinations thereof. The resins can also be functionalized, such as carboxylated, sulfonated, or the like, and particularly such as sodio sulfonated, if desired.

The amorphous polyester resin may be a branched resin. As used herein, the terms “branched” or “branching” includes branched resin and/or cross-linked resins. Branching agents for use in forming these branched resins include, for example, a multivalent polyacid such as 1,2,4-benzene-tricarboxylic acid, 1,2,4-cyclohexanetricarboxylic acid, 2,5,7-naphthalenetricarboxylic acid, 1,2,4-naphthalenetricarboxylic acid, 1,2,5-hexanetricarboxylic acid, 1,3-dicarboxyl-2-methyl-2-methylene-carboxylpropane, tetra(methylene-carboxyl)methane, and 1,2,7,8-octanetetracarboxylic acid, acid anhydrides thereof, and lower alkyl esters thereof, 1 to about 6 carbon atoms; a multivalent polyol such as sorbitol, 1,2,3,6-hexanetetrol, 1,4-sorbitane, pentaerythritol, dipentaerythritol, tripentaerythritol, sucrose, 1,2,4-butanetriol, 1,2,5-pentatriol, glycerol, 2-methylpropanetriol, 2-methyl-1,2,4-butanetriol, trimethylolethane, trimethylolpropane, 1,3,5-trihydroxymethylbenzene, mixtures thereof, and the like. The branching agent amount selected is, for example, from about 0.1 to about 5 mole percent of the resin.

Linear or branched unsaturated polyesters selected for reactions include both saturated and unsaturated diacids (or anhydrides) and dihydric alcohols (glycols or diols). The resulting unsaturated polyesters are reactive (for example, crosslinkable) on two fronts: (i) unsaturation sites (double bonds) along the polyester chain, and (ii) functional groups such as carboxyl, hydroxy, and the like groups amenable to acid-base reactions. Typical unsaturated polyester resins may be prepared by melt polycondensation or other polymerization processes using diacids and/or anhydrides and diols.

In embodiments, a suitable amorphous resin utilized in a toner of the present disclosure may be a low molecular weight amorphous resin, sometimes referred to, in embodiments, as an oligomer, having a weight average molecular weight (Mw) of from about 500 grams/mole to about 10,000 grams/mole, in embodiments from about 1000 grams/mole to about 5000 grams/mole, in other embodiments from about 1500 grams/mole to about 4000 grams/mole.

The low molecular weight amorphous resin may possess a glass transition temperature (Tg) of from about 50° C. to about 70° C., in embodiments from about 57° C. to about 63° C. These low molecular weight amorphous resins may be referred to, in embodiments, as a high Tg amorphous resin.

The low molecular weight amorphous resin may possess a softening point of from about 105° C. to about 120° C., in embodiments from about 110° C. to about 118° C.

The low molecular weight amorphous polyester resins may have an acid value of from about 8 to about 20 mg KOH/g, in embodiments from about 9 to about 16 mg KOH/g, and in embodiments from about 11 to about 15 mg KOH/g. The acid containing resin may be dissolved in tetrahydrofuran solution. The acid number may be detected by titration with KOH/methanol solution containing phenolphthalein as the indicator. The acid number may then be calculated based on the equivalent amount of KOH/methanol required to neutralize all the acid groups on the resin identified as the end point of the titration.

In other embodiments, an amorphous resin utilized in forming a toner of the present disclosure may be a high molecular weight amorphous resin. As used herein, the high molecular weight amorphous polyester resin may have, for example, a number average molecular weight (Mₙ), as measured by gel permeation chromatography (GPC) of, for example, from about 1,000 grams/mole to about 10,000 grams/mole, in embodiments from about 2,000 grams/mole to about 9,000 grams/mole, in embodiments from about 3,000 grams/mole to about 8,000 grams/mole, and in embodiments from about 6,000 grams/mole to about 7,000 grams/mole. The weight average molecular weight (M_{w}) of the resin is greater than 45,000 grams/mole, for example, from about 45,000 grams/mole to about 150,000 grams/mole, in embodiments from about 50,000 grams/mole to about 100,000 grams/mole, in embodiments from about 63,000 grams/mole to about 94,000 grams/mole, and in embodiments from about 68,000 grams/mole to about 85,000 grams/mole, as determined by GPC using polystyrene standard. The polydispersity index (PD) is above about 4, such as, for example, greater than about 4, in embodiments from about 4 to about 20, in embodiments from about 5 to about 10, and in embodiments from about 6 to about 8, as measured by GPC versus standard polystyrene reference resins. The PD index is the ratio of the weight-average molecular weight (M_{w}) and the number-average molecular weight (Mₙ).

The high molecular weight amorphous polyester resins may have an acid value of from about 8 to about 18 mg KOH/g, in embodiments from about 10 to about 16 mg KOH/g, and in embodiments from about 11 to about 14 mg KOH/g.

The high molecular weight amorphous polyester resins, which are available from a number of sources, can possess various softening points of, for example, from about 105° C. to about 140° C., in embodiments from about 110° C. to about 130° C., in embodiments from about 118° C. to about 128° C.

High molecular weight amorphous resins may possess a glass transition temperature of from about 53° C. to about 59° C., in embodiments from about 54.5° C. to about 57° C. These high molecular weight amorphous resins may be referred to, in embodiments, as a low Tg amorphous resin.

The amorphous resin(s) is generally present in the toner composition in various suitable amounts, such as from about 60 to about 95 percent by weight of the toner particles, in embodiments from about 65 to about 70 percent by weight of the toner particles.

In embodiments, a combination of high molecular weight and low molecular weight amorphous resins may be used to form a toner of the present disclosure. The ratio of high molecular weight amorphous resin to low molecular weight amorphous resin may be from about 0:100 to about 100:0, in embodiments from about 30:70 to about 50:50.

In embodiments, the amorphous resin or combination of amorphous resins utilized in the latex may have a glass transition temperature from about 30° C. to about 80° C., in embodiments from about 35° C. to about 70° C. In further embodiments, the combined resins utilized in the latex may have a melt viscosity from about 10 to about 1,000,000 Pa*S at about 130° C., in embodiments from about 50 to about 100,000 Pa*S.

Suitable crystalline resins which may be utilized, optionally in combination with an amorphous resin as described above, include those disclosed in U.S. Patent Application Publication No. 2006/0222991, the disclosure of which is hereby incorporated by reference in its entirety. In embodiments, a suitable crystalline resin may include a resin formed of ethylene glycol and a mixture of dodecanedioic acid and fumaric acid co-monomers with the following formula:

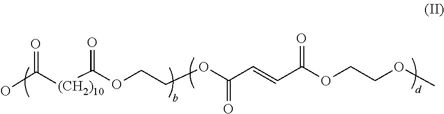

wherein b is from about 5 to about 2000 and d is from about 5 to about 2000.

In embodiments, a crystalline polyester resin may possess acidic groups having an acid number of about 1 mg KOH/g polymer to about 200 mg KOH/g polymer, in embodiments from about 5 mg KOH/g polymer to about 50 mg KOH/g polymer. The crystalline resin may be present in an amount of from about 1 percent by weight to about 85 percent by weight of the toner particles, in embodiments from about 10 percent by weight to about 65 percent by weight of the toner particles.

One, two, or more resins may be used. In embodiments, where two or more resins are used, the resins may be in any suitable ratio (e.g., weight ratio) such as for instance from about 1% (first resin)/99% (second resin) to about 99% (first resin)/1% (second resin), in embodiments from about 10% (first resin)/90% (second resin) to about 90% (first resin)/10% (second resin).

### Solvent

As noted above, bio-based solvents may be used to form the latex. These bio-based solvents may replace currently utilized petrochemical derived solvents, which may be desirable for sustainability, non-dependence on fossil fuels, and reducing carbon emissions. The bio-based solvents can also be easily recycled by distillation.

Suitable bio-based solvents include, for example, 2-methyl-tetrahydrofuran, ethanol, 1,2-propane-diol, 1,3-propane-diol, 1,4-butane-diol, furfuryl alcohol, 2-butyl furan, difurylpropane, ethyl furfuryl ether, 2-bromo furan, 2-butyryl furan, 20-ethyl furan, 2-furaldehyde, 2-furfuryl alcohol, 2-methyl furan, tetrahydrofurfuryl alcohol, 2,5 dimethylfuran, and combinations thereof, in an amount of, for example, from about 1 weight percent to about 200 weight percent of the resin, in embodiments from about 10 weight percent to about 110 weight percent of the resin, in other embodiments from about 50 weight percent to about 100 weight percent of the resin.

In embodiments, suitable bio-based solvents, sometimes referred to, in embodiments, as phase inversion agents, include, for example, 2-methyl-tetrahydrofuran (Me-THF), bio-based ethanol, and combinations thereof. Me-THF is derived from 2-furaldehyde (also known as neural), which is produced from naturally occurring pentoses in agricultural waste like corncobs or bagasse (sugar cane) in a two-step hydrogenation process. Its raw material costs are therefore decoupled from the ever-increasing costs of chemicals derived from oil.

The overall properties of Me-THF are similar to methyl ethyl ketone (MEK), and are slightly more favorable with respect to water solubility and azeotropic distillation. Similarly, isopropanol can be substituted with the less expensive ethanol as a co-solvent, and with slightly improved azeotropic properties. Table 1 below compares the properties of Me-THF with MEK, and the properties of ethanol (Et-OH) with isopropanol (IPA).

TABLE 1

| Properties | MEK | MeTHF | IPA | Et—OH |
|---|---|---|---|---|
| Boiling Point (° C.) | 80 | 80 | 83 | 78.4 |
| Freezing Point (° C.) | −86 | −136 | −90 | −114 |
| Water Azeotrope Boiling Point | 73.4 | 71 | 82.5 | 78.1 |
| (° C.) | | | | |
| Density g/cm³ | 0.80 | 0.855 | 0.79 | 0.79 |
| Flashpoint (° C.) | −9 | −11 | 11.7 | 13.0 |
| Solubility in water (wt %) | 29 | 14 | miscible | miscible |
| Water in Solvent (wt %) | 0.1 | 0.044 | — | — |
| Autoignition Temperature (° C.) | 550 | 270 | 399 | 422 |

In embodiments, the bio-based solvents may be utilized in an amount of, for example, from about 1 weight percent to about 25 weight percent of the resin, in embodiments from about 2 weight percent to about 20 weight percent of the resin, in other embodiments from about 3 weight percent to about 15 weight percent of the resin.

In embodiments, the bio-based solvents solvent may be immiscible in water and may have a boiling point from about 70° C. to about 90° C.

In embodiments, an emulsion formed in accordance with the present disclosure may also include water, in embodiments, de-ionized water (DM, in amounts from about 30% to about 95%, in embodiments, from about 35% to about 60%, at temperatures that melt or soften the resin, from about 20° C. to about 120° C., in embodiments from about 30° C. to about 100° C.

The particle size of the emulsion may be from about 50 nm to about 300 nm, in embodiments from about 100 nm to about 220 nm.

### Neutralizing Agent

In embodiments, the resin may be mixed with a weak base or neutralizing agent. In embodiments, the neutralizing agent may be used to neutralize acid groups in the resins, so a neutralizing agent herein may also be referred to as a “basic neutralization agent.” Any suitable basic neutralization reagent may be used in accordance with the present disclosure. In embodiments, suitable basic neutralization agents may include both inorganic basic agents and organic basic agents. Suitable basic agents may include ammonium hydroxide, potassium hydroxide, sodium hydroxide, sodium carbonate, sodium bicarbonate, lithium hydroxide, potassium carbonate, combinations thereof, and the like. Suitable basic agents may also include monocyclic compounds and polycyclic compounds having at least one nitrogen atom, such as, for example, secondary amines, which include aziridines, azetidines, piperazines, piperidines, pyridines, bipyridines, terpyridines, dihydropyridines, morpholines, N-alkylmorpholines, 1,4-diazabicyclo[2.2.2]octanes, 1,8-diazabicycloundecanes, 1,8-diazabicycloundecenes, dimethylated pentylamines, trimethylated pentylamines, pyrimidines, pyrroles, pyrrolidines, pyrrolidinones, indoles, indolines, indanones, benzindazones, imidazoles, benzimidazoles, imidazolones, imidazolines, oxazoles, isoxazoles, oxazolines, oxadiazoles, thiadiazoles, carbazoles, quinolines, isoquinolines, naphthyridines, triazines, triazoles, tetrazoles, pyrazoles, pyrazolines, and combinations thereof. In embodiments, the monocyclic and polycyclic compounds may be unsubstituted or substituted at any carbon position on the ring.

The basic agent may be utilized in an amount from about 0.001 weight percent to 50 weight percent of the resin, in embodiments from about 0.01 weight percent to about 25 weight percent of the resin, in embodiments from about 0.1 weight percent to 5 weight percent of the resin. In embodiments, the neutralizing agent may be added in the form of an aqueous solution. In other embodiments, the neutralizing agent may be added in the form of a solid.

Utilizing the above basic neutralization agent in combination with a resin possessing acid groups, a neutralization ratio from about 25% to about 500% may be achieved, in embodiments from about 50% to about 300%. In embodiments, the neutralization ratio may be calculated as the molar ratio of basic groups provided with the basic neutralizing agent to the acid groups present in the resin multiplied by 100%.

As noted above, the basic neutralization agent may be added to a resin possessing acid groups. The addition of the basic neutralization agent may thus raise the pH of an emulsion including a resin possessing acid groups from about 8 to about 14, in embodiments, from about 9 to about 11. The neutralization of the acid groups may, in embodiments, enhance formation of the emulsion.

### Surfactants

In embodiments, a surfactant may be added to the resin and solvent to form the emulsion.

Where utilized, a resin emulsion may include one, two, or more surfactants. The surfactants may be selected from ionic surfactants and nonionic surfactants. Anionic surfactants and cationic surfactants are encompassed by the term “ionic surfactants.” In embodiments, the surfactant may be added as a solid or as a solution with a concentration from about 5% to about 100% (pure surfactant) by weight, in embodiments, from about 10% to about 95 weight percent. In embodiments, the surfactant may be utilized so that it is present in an amount from about 0.01 weight percent to about 20 weight percent of the resin, in embodiments, from about 0.1 weight percent to about 16 weight percent of the resin, in other embodiments, from about 1 weight percent to about 14 weight percent of the resin.

Anionic surfactants which may be utilized include sulfates and sulfonates, sodium dodecylsulfate (SDS), sodium dodecylbenzene sulfonate, sodium dodecylnaphthalene sulfate, dialkyl benzenealkyl sulfates and sulfonates, acids such as abitic acid available from Aldrich, NEOGEN R™, NEOGEN SC™ obtained from Daiichi Kogyo Seiyaku, combinations thereof, and the like. Other suitable anionic surfactants include, in embodiments, DOWFAXTM™™2A1, an alkyldiphenyloxide disulfonate from The Dow Chemical Company, and/or TAYCA POWER BN2060 from Tayca Corporation (Japan), which are branched sodium dodecylbenzene sulfonates. Combinations of these surfactants and any of the foregoing anionic surfactants may be utilized in embodiments.

Examples of the cationic surfactants, which are usually positively charged, include, for example, alkylbenzyl dimethyl ammonium chloride, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, MIRAPOL™ and ALKAQUAT™, available from Alkaril Chemical Company, SANIZOL™ (benzalkonium chloride), available from Kao Chemicals, and the like, and mixtures thereof.

Examples of nonionic surfactants that may be utilized for the processes illustrated herein include, for example, polyacrylic acid, methalose, methyl cellulose, ethyl cellulose, propyl cellulose, hydroxy ethyl cellulose, carboxy methyl cellulose, polyoxyethylene cetyl ether, polyoxyethylene lauryl ether, polyoxyethylene octyl ether, polyoxyethylene octylphenyl ether, polyoxyethylene oleyl ether, polyoxyethylene sorbitan monolaurate, polyoxyethylene stearyl ether, polyoxyethylene nonylphenyl ether, dialkylphenoxy poly(ethyleneoxy)ethanol, available from Rhone-Poulenc as IGEPAL CA-210™, IGEPAL CA-520™, IGEPAL CA-720™, IGEPAL CO-890™, IGEPAL CO-720™, IGEPAL CO-290™, IGEPAL CA-210™, ANTAROX 890™ and ANTAROX 897™. Other examples of suitable nonionic surfactants may include a block copolymer of polyethylene oxide and polypropylene oxide, including those commercially available as SYNPERONIC PE/F, in embodiments SYNPERONIC PE/F 108. Combinations of these surfactants and any of the foregoing surfactants may be utilized in embodiments.

### Processing

The present process includes melt mixing a mixture at an elevated temperature containing at least one polyester resin, a bio-based solvent, optionally a surfactant, and a neutralizing agent to form a latex emulsion. In embodiments, the resins may be pre-blended prior to melt mixing.

More than one resin may be utilized in forming the latex. As noted above, the resin may be a crystalline resin. In embodiments, the resin may be a crystalline resin and the elevated temperature may be a temperature above the crystallization temperature of the crystalline resin. In further embodiments, the resin may be an amorphous resin or a mixture of amorphous and crystalline resins and the temperature may be above the glass transition temperature of the mixture.

Thus, in embodiments, a process of the present disclosure may include contacting at least one resin with a bio-based solvent to form a resin mixture, heating the resin mixture to an elevated temperature, stirring the mixture, adding a neutralizing agent to neutralize the acid groups of the resin, adding water dropwise into the mixture until phase inversion occurs to form a phase inversed latex emulsion, distilling the latex to remove a water/solvent mixture in the distillate and producing a high quality latex, and separating the solvent from the water in the distillate. The solvent thus separated from the distillate may, in embodiments, be re-used, making the processes of the present disclosure very environmentally friendly.

In the phase inversion process, the polyester resins may be dissolved in a bio-based solvent noted above, at a concentration from about 1 weight percent to about 85 weight percent resin in solvent, in embodiments from about 5 weight percent to about 60 weight percent resin in solvent.

The resin mixture is then heated to a temperature from about 25° C. to about 90° C., in embodiments from about 30° C. to about 85° C. The heating need not be held at a constant temperature, but may be varied. For example, the heating may be slowly or incrementally increased until a desired temperature is achieved.

In accordance with the present disclosure, a crystalline and/or an amorphous polyester latex may be obtained using a two solvent PIE process which requires dispersing and solvent stripping steps. In this process, the polyester resin may be dissolved in a combination of two bio-based solvents, for example, Me-THF and ethanol, to produce a homogenous phase.

A fixed amount of base solution (such as ammonium hydroxide) is then added into this organic phase to neutralize acid end groups on the polyester chain, followed by the addition of de-ionized water (DIW) to form a uniform dispersion of polyester particles in water through phase inversion. The bio-based solvents remain in both the polyester particles and water phase at this stage. Through vacuum distillation, the solvents are stripped off.

In embodiments, the neutralizing agent or base solution which may be utilized in the process of the present disclosure includes the agents mentioned hereinabove. In embodiments, the optional surfactant utilized may be any of the surfactants mentioned hereinabove to ensure that proper resin neutralization occurs and leads to a high quality latex with low coarse content.

In embodiments, the surfactant may be added to the one or more ingredients of the resin composition before, during, or after melt-mixing. In embodiments, the surfactant may be added before, during, or after the addition of the neutralizing agent. In embodiments, the surfactant may be added prior to the addition of the neutralizing agent. In embodiments, a surfactant may be added to the pre-blend mixture prior to melt mixing.

The melt-mixing temperature may be from about 25° C. to about 200° C., in embodiments from about 40° C. to about 90° C., in other embodiments from about 50° C. to about 80° C.

Once the resins, neutralizing agent and optional surfactant are melt mixed, the mixture may then be contacted with water, to form a latex emulsion. Water may be added in order to form a latex with a solids content from about 5% to about 50%, in embodiments, from about 10% to about 45%. While higher water temperatures may accelerate the dissolution process, latexes can be formed at temperatures as low as room temperature. In other embodiments, water temperatures may be from about 40° C. to about 110° C., in embodiments, from about 50° C. to about 100° C.

In embodiments, a continuous phase inversed emulsion may be formed. Phase inversion can be accomplished by continuing to add an aqueous alkaline solution or basic agent, optional surfactant and/or water compositions to create a phase inversed emulsion which includes a disperse phase including droplets possessing the molten ingredients of the resin composition, and a continuous phase including the surfactant and/or water composition.

Melt mixing may be conducted, in embodiments, utilizing any means within the purview of those skilled in the art. For example, melt mixing may be conducted in a glass kettle with an anchor blade impeller, an extruder, i.e. a twin screw extruder, a kneader such as a Haake mixer, a batch reactor, or any other device capable of intimately mixing viscous materials to create near homogenous mixtures.

Stirring, although not necessary, may be utilized to enhance formation of the latex. Any suitable stirring device may be utilized. In embodiments, the stirring may be at a speed from about 10 revolutions per minute (rpm) to about 5,000 rpm, in embodiments from about 20 rpm to about 2,000 rpm, in other embodiments from about 50 rpm to about 1,000 rpm. The stirring need not be at a constant speed, but may be varied. For example, as the heating of the mixture becomes more uniform, the stirring rate may be increased. In embodiments, a homogenizer (that is, a high shear device), may be utilized to form the phase inversed emulsion, but in other embodiments, the process of the present disclosure may take place without the use of a homogenizer. Where utilized, a homogenizer may operate at a rate from about 3,000 rpm to about 10,000 rpm.

Although the point of phase inversion may vary depending on the components of the emulsion, the temperature of heating, the stirring speed, and the like, phase inversion may occur when the basic neutralization agent, optional surfactant, and/or water has been added so that the resulting resin is present in an amount from about 5 weight percent to about 70 weight percent of the emulsion, in embodiments from about 20 weight percent to about 65 weight percent of the emulsion, in other embodiments from about 30 weight percent to about 60 weight percent of the emulsion.

Following phase inversion, additional surfactant, water, and/or aqueous alkaline solution may optionally be added to dilute the phase inversed emulsion, although this is not required. Following phase inversion, the phase inversed emulsion may be cooled to room temperature, for example from about 20° C. to about 25° C.

The latex emulsions of the present disclosure may then be utilized to produce particles that are suitable for emulsion aggregation ultra low melt processes.

The emulsified resin particles in the aqueous medium may have a submicron size, for example of about 1 μm or less, in embodiments about 500 nm or less, such as from about 10 nm to about 500 nm, in embodiments from about 50 nm to about 400 nm, in other embodiments from about 100 nm to about 300 nm, in some embodiments about 200 nm. Adjustments in particle size can be made by modifying the ratio of water to resin, the neutralization ratio, solvent concentration, and solvent composition.

The coarse content of the latex of the present disclosure may be from about 0.01 weight percent to about 5 weight percent, in embodiments, from about 0.1 weight percent to about 3 weight percent. The solids content of the latex of the present disclosure may be from about 5 weight percent to about 50 weight percent, in embodiments, from about 20 weight percent to about 40 weight percent.

In embodiments, the molecular weight of the resin emulsion particles of the present disclosure may be from about 18,000 grams/mole to about 26,000 grams/mole, in embodiments from about 21,500 grams/mole to about 25,000 grams/mole, in embodiments from about 23,000 grams/mole to about 24,000 grams/mole.

### Toner

Once the resin mixture has been contacted with water to form an emulsion and the solvent removed from this mixture as described above, the resulting latex may then be utilized to form a toner by any method within the purview of those skilled in the art. The latex emulsion may be contacted with a colorant, optionally in a dispersion, and other additives to form an ultra low melt toner by a suitable process, in embodiments, an emulsion aggregation and coalescence process.

In embodiments, the optional additional ingredients of a toner composition including colorants, waxes, and other additives, may be added before, during or after melt mixing the resin to form the latex emulsion of the present disclosure. The additional ingredients may be added before, during or after formation of the latex emulsion. In further embodiments, the colorant may be added before the addition of the surfactant.

### Colorants

As the colorant to be added, various known suitable colorants, such as dyes, pigments, mixtures of dyes, mixtures of pigments, mixtures of dyes and pigments, and the like, may be included in the toner. The colorant may be added in amounts from about 0.1 to about 35 weight percent of the toner, in embodiments from about 1 to about 15 weight percent of the toner, in embodiments from about 3 to about 10 weight percent of the toner.

As examples of suitable colorants, mention may be made of carbon black like REGAL 330®; magnetites, such as Mobay magnetites M08029™, MO8060™; Columbian magnetites; MAPICO BLACKS™ and surface treated magnetites; Pfizer magnetites CB4799™, CB5300™, CB5600™, MCX6369™; Bayer magnetites, BAYFERROX 8600™, 8610™; Northern Pigments magnetites, NP-604™, NP-608™; Magnox magnetites TMB-100™, or TMB-104™; and the like. As colored pigments, there can be selected cyan, magenta, yellow, red, green, brown, blue or mixtures thereof. Generally, cyan, magenta, or yellow pigments or dyes, or mixtures thereof, are used. The pigment or pigments are generally used as water based pigment dispersions.

Specific examples of pigments include SUNSPERSE 6000, FLEXIVERSE and AQUATONE water based pigment dispersions from SUN Chemicals, HELIOGEN BLUE L6900™, D6840™, D7080™, D7020™, PYLAM OIL BLUE™, PYLAM OIL YELLOW™, PIGMENT BLUE 1™ available from Paul Uhlich & Company, Inc., PIGMENT VIOLET 1™, PIGMENT RED 48™, LEMON CHROME YELLOW DCC 1026™, E.D. TOLUIDINE RED™ and BON RED C™ available from Dominion Color Corporation, Ltd., Toronto, Ontario, NOVAPERM YELLOW FGL™, HOSTAPERM PINK E™ from Hoechst, and CINQUASIA MAGENTA™ available from E.I. DuPont de Nemours & Company, and the like. Generally, colorants that can be selected are black, cyan, magenta, or yellow, and mixtures thereof. Examples of magentas are 2,9-dimethyl-substituted quinacridone and anthraquinone dye identified in the Color Index as CI-60710, CI Dispersed Red 15, diazo dye identified in the Color Index as CI-26050, CI Solvent Red 19, and the like. Illustrative examples of cyans include copper tetra(octadecyl sulfonamido) phthalocyanine, x-copper phthalocyanine pigment listed in the Color Index as CI-74160, CI Pigment Blue, Pigment Blue 15:3, and Anthrathrene Blue, identified in the Color Index as CI-69810, Special Blue X-2137, and the like. Illustrative examples of yellows are diarylide yellow 3,3-dichlorobenzidene acetoacetanilides, a monoazo pigment identified in the Color Index as CI 12700, CI Solvent Yellow 16, a nitrophenyl amine sulfonamide identified in the Color Index as Foron Yellow SE/GLN, CI Dispersed Yellow 33 2,5-dimethoxy-4-sulfonanilide phenylazo-4′-chloro-2,5-dimethoxy acetoacetanilide, and Permanent Yellow FGL. Colored magnetites, such as mixtures of MAPICO BLACK™, and cyan components may also be selected as colorants. Other known colorants can be selected, such as Levanyl Black A-SF (Miles, Bayer) and Sunsperse Carbon Black LHD 9303 (Sun Chemicals), and colored dyes such as Neopen Blue (BASF), Sudan Blue OS (BASF), PV Fast Blue B2G01 (American Hoechst), Sunsperse Blue BHD 6000 (Sun Chemicals), Irgalite Blue BCA (Ciba-Geigy), Paliogen Blue 6470 (BASF), Sudan III (Matheson, Coleman, Bell), Sudan II (Matheson, Coleman, Bell), Sudan IV (Matheson, Coleman, Bell), Sudan Orange G (Aldrich), Sudan Orange 220 (BASF), Paliogen Orange 3040 (BASF), Ortho Orange OR 2673 (Paul Uhlich), Paliogen Yellow 152, 1560 (BASF), Lithol Fast Yellow 0991K (BASF), Paliotol Yellow 1840 (BASF), Neopen Yellow (BASF), Novoperm Yellow FG 1 (Hoechst), Permanent Yellow YE 0305 (Paul Uhlich), Lumogen Yellow D0790 (BASF), Sunsperse Yellow YHD 6001 (Sun Chemicals), Suco-Gelb L1250 (BASF), Suco-Yellow D1355 (BASF), Hostaperm Pink E (American Hoechst), Fanal Pink D4830 (BASF), Cinquasia Magenta (DuPont), Lithol Scarlet D3700 (BASF), Toluidine Red (Aldrich), Scarlet for Thermoplast NSD PS PA (Ugine Kuhlmann of Canada), E.D. Toluidine Red (Aldrich), Lithol Rubine Toner (Paul Uhlich), Lithol Scarlet 4440 (BASF), Bon Red C (Dominion Color Company), Royal Brilliant Red RD-8192 (Paul Uhlich), Oracet Pink RF (Ciba-Geigy), Paliogen Red 3871K (BASF), Paliogen Red 3340 (BASF), Lithol Fast Scarlet L4300 (BASF), combinations of the foregoing, and the like.

### Wax

Optionally, a wax may also be combined with the resin and a colorant in forming toner particles. The wax may be provided in a wax dispersion, which may include a single type of wax or a mixture of two or more different waxes. A single wax may be added to toner formulations, for example, to improve particular toner properties, such as toner particle shape, presence and amount of wax on the toner particle surface, charging and/or fusing characteristics, gloss, stripping, offset properties, and the like. Alternatively, a combination of waxes can be added to provide multiple properties to the toner composition.

When included, the wax may be present in an amount of, for example, from about 1 weight percent to about 25 weight percent of the toner particles, in embodiments from about 5 weight percent to about 20 weight percent of the toner particles.

When a wax dispersion is used, the wax dispersion may include any of the various waxes conventionally used in emulsion aggregation toner compositions. Waxes that may be selected include waxes having, for example, an average molecular weight from about 500 to about 20,000, in embodiments from about 1,000 to about 10,000. Waxes that may be used include, for example, polyolefins such as polyethylene including linear polyethylene waxes and branched polyethylene waxes, polypropylene including linear polypropylene waxes and branched polypropylene waxes, polyethylene/amide, polyethylenetetrafluoroethylene, polyethylenetetrafluoroethylene/amide, and polybutene waxes such as commercially available from Allied Chemical and Petrolite Corporation, for example POLYWAX™ polyethylene waxes such as commercially available from Baker Petrolite, wax emulsions available from Michaelman, Inc. and the Daniels Products Company, EPOLENE N-15™ commercially available from Eastman Chemical Products, Inc., and VISCOL 550-P™, a low weight average molecular weight polypropylene available from Sanyo Kasei K. K.; plant-based waxes, such as carnauba wax, rice wax, candelilla wax, sumacs wax, and jojoba oil; animal-based waxes, such as beeswax; mineral-based waxes and petroleum-based waxes, such as montan wax, ozokerite, ceresin, paraffin wax, microcrystalline wax such as waxes derived from distillation of crude oil, silicone waxes, mercapto waxes, polyester waxes, urethane waxes; modified polyolefin waxes (such as a carboxylic acid-terminated polyethylene wax or a carboxylic acid-terminated polypropylene wax); Fischer-Tropsch wax; ester waxes obtained from higher fatty acid and higher alcohol, such as stearyl stearate and behenyl behenate; ester waxes obtained from higher fatty acid and monovalent or multivalent lower alcohol, such as butyl stearate, propyl oleate, glyceride monostearate, glyceride distearate, and pentaerythritol tetra behenate; ester waxes obtained from higher fatty acid and multivalent alcohol multimers, such as diethylene glycol monostearate, dipropylene glycol distearate, diglyceryl distearate, and triglyceryl tetrastearate; sorbitan higher fatty acid ester waxes, such as sorbitan monostearate, and cholesterol higher fatty acid ester waxes, such as cholesteryl stearate. Examples of functionalized waxes that may be used include, for example, amines, amides, for example AQUA SUPERSLIP 6550™, SUPERSLIP 6530™ available from Micro Powder Inc., fluorinated waxes, for example POLYFLUO 190™, POLYFLUO 200™, POLYSILK 19™, POLYSILK 14™ available from Micro Powder Inc., mixed fluorinated, amide waxes, such as aliphatic polar amide functionalized waxes; aliphatic waxes consisting of esters of hydroxylated unsaturated fatty acids, for example MICROSPERSION 19™ also available from Micro Powder Inc., imides, esters, quaternary amines, carboxylic acids or acrylic polymer emulsion, for example JONCRYL 74™, 89™, 130™, 537™, and 538™, all available from SC Johnson Wax, and chlorinated polypropylenes and polyethylenes available from Allied Chemical and Petrolite Corporation and SC Johnson wax. Mixtures and combinations of the foregoing waxes may also be used in embodiments. Waxes may be included as, for example, fuser roll release agents. In embodiments, the waxes may be crystalline or non-crystalline.

In embodiments, the wax may be incorporated into the toner in the form of one or more aqueous emulsions or dispersions of solid wax in water, where the solid wax particle size may be from about 100 nm to about 300 nm.

### Toner Preparation

The toner particles may be prepared by any method within the purview of one skilled in the art. Although embodiments relating to toner particle production are described below with respect to emulsion aggregation processes, any suitable method of preparing toner particles may be used, including chemical processes, such as suspension and encapsulation processes disclosed in U.S. Pat. Nos. 5,290,654 and 5,302,486, the disclosures of each of which are hereby incorporated by reference in their entirety. In embodiments, toner compositions and toner particles may be prepared by aggregation and coalescence processes in which small-size resin particles are aggregated to the appropriate toner particle size and then coalesced to achieve the final toner particle shape and morphology.

In embodiments, toner compositions may be prepared by emulsion aggregation processes, such as a process that includes aggregating a mixture of an optional colorant, an optional wax and any other desired or required additives, and emulsions including the resins described above, optionally in surfactants as described above, and then coalescing the aggregate mixture. A mixture may be prepared by adding a colorant and optionally a wax or other materials, which may also be optionally in a dispersion(s) including a surfactant, to the emulsion, which may be a mixture of two or more emulsions containing the resin. The pH of the resulting mixture may be adjusted by an acid such as, for example, acetic acid, nitric acid or the like. In embodiments, the pH of the mixture may be adjusted to from about 2 to about 5. Additionally, in embodiments, the mixture may be homogenized. If the mixture is homogenized, homogenization may be accomplished by mixing at about 600 to about 6,000 revolutions per minute. Homogenization may be accomplished by any suitable means, including, for example, an IKA ULTRA TURRAX T50 probe homogenizer.

Following the preparation of the above mixture, an aggregating agent may be added to the mixture. Any suitable aggregating agent may be utilized to form a toner. Suitable aggregating agents include, for example, aqueous solutions of a divalent cation or a multivalent cation material. The aggregating agent may be, for example, an inorganic cationic aggregating agent such as polyaluminum halides such as polyaluminum chloride (PAC), or the corresponding bromide, fluoride, or iodide, polyaluminum silicates such as polyaluminum sulfosilicate (PASS), and water soluble metal salts including aluminum chloride, aluminum nitrite, aluminum sulfate, potassium aluminum sulfate, calcium acetate, calcium chloride, calcium nitrite, calcium oxylate, calcium sulfate, magnesium acetate, magnesium nitrate, magnesium sulfate, zinc acetate, zinc nitrate, zinc sulfate, zinc chloride, zinc bromide, magnesium bromide, copper chloride, copper sulfate, and combinations thereof. In embodiments, the aggregating agent may be added to the mixture at a temperature that is below the glass transition temperature (Tg) of the resin.

Suitable examples of organic cationic aggregating agents include, for example, dialkyl benzenealkyl ammonium chloride, lauryl trimethyl ammonium chloride, alkylbenzyl methyl ammonium chloride, alkyl benzyl dimethyl ammonium bromide, benzalkonium chloride, cetyl pyridinium bromide, C₁₂, C₁₅, C₁₇ trimethyl ammonium bromides, halide salts of quaternized polyoxyethylalkylamines, dodecylbenzyl triethyl ammonium chloride, combinations thereof, and the like.

Other suitable aggregating agents also include, but are not limited to, tetraalkyl titinates, dialkyltin oxide, tetraalkyltin oxide hydroxide, dialkyltin oxide hydroxide, aluminum alkoxides, alkyl zinc, dialkyl zinc, zinc oxides, stannous oxide, dibutyltin oxide, dibutyltin oxide hydroxide, tetraalkyl tin, combinations thereof, and the like. Where the aggregating agent is a polyion aggregating agent, the agent may have any desired number of polyion atoms present. For example, in embodiments, suitable polyaluminum compounds have from about 2 to about 13, in other embodiments, from about 3 to about 8, aluminum ions present in the compound.

The aggregating agent may be added to the mixture utilized to form a toner in an amount of, for example, from about 0 to about 10 weight percent, in embodiments from about 0.2 to about 8 weight percent, in other embodiments from about 0.5 to about 5 weight percent, of the resin in the mixture. This should provide a sufficient amount of agent for aggregation.

The particles may be permitted to aggregate until a predetermined desired particle size is obtained. A predetermined desired size refers to the desired particle size to be obtained as determined prior to formation, and the particle size being monitored during the growth process until such particle size is reached. Samples may be taken during the growth process and analyzed, for example with a Coulter Counter, for average particle size. The aggregation thus may proceed by maintaining the elevated temperature, or slowly raising the temperature to, for example, from about 40° C. to about 100° C., and holding the mixture at this temperature for a time from about 0.5 hours to about 6 hours, in embodiments from about hour 1 to about 5 hours, while maintaining stirring, to provide the aggregated particles. Once the predetermined desired particle size is reached, then the growth process is halted.

The growth and shaping of the particles following addition of the aggregation agent may be accomplished under any suitable conditions. For example, the growth and shaping may be conducted under conditions in which aggregation occurs separate from coalescence. For separate aggregation and coalescence stages, the aggregation process may be conducted under shearing conditions at an elevated temperature, for example from about 40° C. to about 90° C., in embodiments from about 45° C. to about 80° C., which may be below the glass transition temperature of the resin as discussed above.

Once the desired final size of the toner particles is achieved, the pH of the mixture may be adjusted with a base to a value from about 3 to about 10, and in embodiments from about 5 to about 9. The adjustment of the pH may be utilized to freeze, that is to stop, toner growth. The base utilized to stop toner growth may include any suitable base such as, for example, alkali metal hydroxides such as, for example, sodium hydroxide, potassium hydroxide, ammonium hydroxide, combinations thereof, and the like. In embodiments, ethylene diamine tetraacetic acid (EDTA) may be added to help adjust the pH to the desired values noted above.

In embodiments, the final size of the toner particles may be from about 2 μm to about 12 μm, in embodiments from about 3 μm to about 10 p.m.

### Shell Resin

In embodiments, after aggregation, but prior to coalescence, a resin coating may be applied to the aggregated particles to form a shell thereover. In embodiments, the core may thus include a crystalline resin, as described above. Any resin described above may be utilized as the shell. In embodiments, a polyester amorphous resin latex as described above may be included in the shell. In embodiments, the polyester amorphous resin latex described above may be combined with a different resin, and then added to the particles as a resin coating to form a shell.

In embodiments, resins which may be utilized to form a shell include, but are not limited to, the amorphous resins described above. In embodiments, an amorphous resin which may be utilized to form a shell in accordance with the present disclosure includes an amorphous polyester. Multiple resins may be utilized in any suitable amounts. In embodiments, a first amorphous polyester resin, for example an amorphous resin of formula I above, may be present in an amount from about 20 percent by weight to about 100 percent by weight of the total shell resin, in embodiments from about 30 percent by weight to about 90 percent by weight of the total shell resin. Thus, in embodiments, a second resin may be present in the shell resin in an amount from about 0 percent by weight to about 80 percent by weight of the total shell resin, in embodiments from about 10 percent by weight to about 70 percent by weight of the shell resin.

The shell resin may be applied to the aggregated particles by any method within the purview of those skilled in the art. In embodiments, the resins utilized to form the shell may be in an emulsion including any surfactant described above. The emulsion possessing the resins may be combined with the aggregated particles described above so that the shell forms over the aggregated particles.

The formation of the shell over the aggregated particles may occur while heating to a temperature from about 30° C. to about 80° C., in embodiments from about 35° C. to about 70° C. The formation of the shell may take place for a period of time from about 5 minutes to about 10 hours, in embodiments from about 10 minutes to about 5 hours.

The shell may be present in an amount from about 1 percent by weight to about 80 percent by weight of the toner components, in embodiments from about 10 percent by weight to about 40 percent by weight of the toner components, in still further embodiments from about 20 percent by weight to about 35 percent by weight of the toner components.

### Coalescence

Following aggregation to the desired particle size and application of any optional shell, the particles may then be coalesced to the desired final shape, the coalescence being achieved by, for example, heating the mixture to a temperature from about 45° C. to about 100° C., in embodiments from about 55° C. to about 99° C., which may be at or above the glass transition temperature of the resins utilized to form the toner particles, and/or reducing the stirring, for example to from about 1000 rpm to about 100 rpm, in embodiments from about 800 rpm to about 200 rpm. Coalescence may be accomplished over a period from about 0.01 to about 9 hours, in embodiments from about 0.1 to about 4 hours.

After aggregation and/or coalescence, the mixture may be cooled to room temperature, such as from about 20° C. to about 25° C. The cooling may be rapid or slow, as desired. A suitable cooling method may include introducing cold water to a jacket around the reactor. After cooling, the toner particles may be optionally washed with water, and then dried. Drying may be accomplished by any suitable method for drying including, for example, freeze-drying.

### Additives

In embodiments, the toner particles may also contain other optional additives, as desired or required. For example, the toner may include positive or negative charge control agents, for example in an amount from about 0.1 to about 10 weight percent of the toner, in embodiments from about 1 to about 3 weight percent of the toner. Examples of suitable charge control agents include quaternary ammonium compounds inclusive of alkyl pyridinium halides; bisulfates; alkyl pyridinium compounds, including those disclosed in U.S. Pat. No. 4,298,672, the disclosure of which is hereby incorporated by reference in its entirety; organic sulfate and sulfonate compositions, including those disclosed in U.S. Pat. No. 4,338,390, the disclosure of which is hereby incorporated by reference in its entirety; cetyl pyridinium tetrafluoroborates; distearyl dimethyl ammonium methyl sulfate; aluminum salts such as BONTRON E84™ or E88™ (Orient Chemical Industries, Ltd.); combinations thereof, and the like.

There can also be blended with the toner particles external additive particles after formation including flow aid additives, which additives may be present on the surface of the toner particles. Examples of these additives include metal oxides such as titanium oxide, silicon oxide, aluminum oxides, cerium oxides, tin oxide, mixtures thereof, and the like; colloidal and amorphous silicas, such as AEROSIL®, metal salts and metal salts of fatty acids inclusive of zinc stearate, calcium stearate, or long chain alcohols such as UNILIN 700, and mixtures thereof.

In general, silica may be applied to the toner surface for toner flow, triboelectric charge enhancement, admix control, improved development and transfer stability, and higher toner blocking temperature. TiO₂ may be applied for improved relative humidity (RH) stability, triboelectric charge control and improved development and transfer stability. Zinc stearate, calcium stearate and/or magnesium stearate may optionally also be used as an external additive for providing lubricating properties, developer conductivity, triboelectric charge enhancement, enabling higher toner charge and charge stability by increasing the number of contacts between toner and carrier particles. In embodiments, a commercially available zinc stearate known as Zinc Stearate L, obtained from Ferro Corporation, may be used. The external surface additives may be used with or without a coating.

Each of these external additives may be present in an amount from about 0.1 weight percent to about 5 weight percent of the toner, in embodiments from about 0.25 weight percent to about 3 weight percent of the toner, although the amount of additives can be outside of these ranges. In embodiments, the toners may include, for example, from about 0.1 weight percent to about 5 weight percent titania, from about 0.1 weight percent to about 8 weight percent silica, and from about 0.1 weight percent to about 4 weight percent zinc stearate.

Suitable additives include those disclosed in U.S. Pat. Nos. 3,590,000, and 6,214,507, the disclosures of each of which are hereby incorporated by reference in their entirety.

The following Examples are being submitted to illustrate embodiments of the present disclosure. These Examples are intended to be illustrative only and are not intended to limit the scope of the present disclosure. Also, parts and percentages are by weight unless otherwise indicated. As used herein, “room temperature” refers to a temperature from about 20° C. to about 25° C.

### EXAMPLES

### Examples 1-9

General procedure for phase inversion emulsification (PIE). Two sets of emulsions were prepared: Examples 1-5 were emulsions of a low molecular weight amorphous resin, including an alkoxylated bisphenol A with terephthalic acid, fumaric acid, and dodecenylsuccinic acid co-monomers, and Examples 6-9 were emulsions of a high molecular weight amorphous resin including alkoxylated bisphenol A with terephthalic acid, trimellitic acid, and dodecenylsuccinic acid co-monomers.

2-Methyltrahydrofuran (Me-THF) and either isopropanol or ethyl alcohol were weighed out separately (see Tables 2 and 3 below for amounts of resins and solvents for each of Examples 1-9) and mixed together in a beaker.

Each resin was charged in a reactor as set forth in Table 2 (Batch Size). The mixed solvents were then added to the reactor. The heater of the reactor was set to about 42° C. (to maintain the reactor temperature at about 40° C.). The agitator (an anchor blade impeller) was switched on to rotate at approximately 100 revolutions per minute (rpm). After about 1.5 hours, when all of the resins had dissolved, about 10% NH₄OH was added to the mixture drop-wise, with a disposable pipette through a rubber stopper, over a period of about 2 minutes. The mixture was left alone for about 10 minutes.

The speed of the agitator was then adjusted to about 200 rpm, and excess de-ionized water (DIW) was added to the reactor by a pump through a pipe connected to the top of the reactor, at a rate of about 2.2 grams/minute. The speed of the agitator was reduced to about 150 rpm, with agitation continuing for about 30 minutes.

The mixture was then discharged to a glass pan, and the solvents were removed by distillation at a temperature of from about 80° C. to about 85° C. until less than about 200 parts per million (ppm) of the solvents remained.

A sample of the resin emulsion was taken before evaporation to determine particle size. Particle size, solids percentage, and pH were then obtained on the final product. The sample was submitted for gas chromatography (GC) to analyze the residual solvents (Me-THF and ethyl alcohol). Table 2 below summarizes the resins, solvent systems, and particle sizes for the emulsions of Examples 1-5, and Table 3 summarizes the resins, solvent systems, and particle sizes for the emulsions of Examples 6-9.

TABLE 2
Emulsification of low molecular weight amorphous resin

| | | | | | | | Par- |
|---|---|---|---|---|---|---|---|
| | | | | | | NH₄OH | ticle |
| Exam- | Batch | Resin | Me—THF | IPA | Et—OH | 10% | Size |
| ple | Size | (Parts) | (Parts) | (Parts) | (Parts) | (Parts) | (nm) |
| 1 | 50 ml | 10 | 10 | 3 | — | 0.2 | 175 |
| 2 | 50 ml | 10 | 10 | 3 | — | 0.3 | 97 |
| 3 | 50 ml | 10 | 10 | 3 | — | 0.6 | 152 |
| 4 | 1 L | 10 | 10 | — | 3 | 0.3 | 66 |
| 5 | 50 ml | 10 | 10 | — | 3 | 0.45 | 137 |

TABLE 3
Emulsification of high molecular weight amorphous resin

| | | | | | | | Par- |
|---|---|---|---|---|---|---|---|
| | | | | | | NH₄OH | ticle |
| Exam- | Batch | Resin | Me—THF | IPA | Et—OH | 10% | Size |
| ple | Size | (Parts) | (Parts) | (Parts) | (Parts) | (Parts) | (nm) |
| 6 | 50 ml | 10 | 10 | 3 | — | 0.3 | 86 |
| 7 | 50 ml | 10 | 10 | 3 | — | 0.6 | 150 |
| 8 | 50 ml | 10 | 10 | — | 3 | 0.3 | 341 |
| 9 | 1 L | 10 | 10 | — | 3 | 0.2 | 198.9 |

The latexes from Examples 4 and 9 were characterized with gel permeation chromatography (GPC) to ensure no appreciable degradation occurred. Controls were prepared with the low molecular weight amorphous resin (control 1 for comparison with Example 4) and the high molecular weight amorphous resin (control 2 for comparison with Example 9). Control 1 was prepared following the same process as Example 4, and Control 2 was prepared following the same process as Example 9, except the control samples were made with methyl ethyl ketone/isopropanol solvents (MEK/IPA) instead of Me-THF/IPA.

Mw, Mn, and polydispersity (Pd, which is Mw/Mn) were determined for the latexes. The results are summarized in Table 4 below, showing the molecular weight of the resins of Example 4 was similar to Control 1 and the molecular weight of Example 9 was similar to Control 2.

TABLE 4

| Resin | Mn | Mw | Pd |
|---|---|---|---|
| Control 1 | 4441 | 18866 | 4.24 |
| Example 4 (dried Latex) | 4522 | 18688 | 4.13 |
| Control 2 | 5663 | 158249 | 28 |
| Example 9 (dried Latex) | 5295 | 174203 | 32 |

### Example 10

A cyan EA ULM toner was prepared with a combination of the latexes of Example 4 and Example 9, using the following process.

A 2 liter beaker was charged with about 194 grams of the low molecular weight amorphous polyester resin emulsion of Example 4 and about 194 grams of the high molecular weight amorphous polyester resin emulsion of Example 9. Then, added thereto was about 30 grams of a crystalline resin emulsion of the following formula:

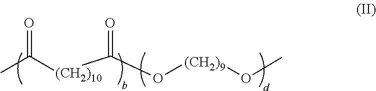

Added thereto was about 2 parts per hundred (pph) of DOWFAX™ 2A1, an alkyldiphenyloxide disulfonate (commercially available from the Dow Chemical Company), about 46 grams of a polyethylene wax (from IGI), and about 53 grams of a cyan pigment (Pigment Blue 15:3 in a dispersion).

The pH was then adjusted to about 4.2 using 0.3M nitric acid. The slurry was then homogenized for about 5 minutes at from about 3000 to about 4000 revolutions per minute (rpm) while adding in the coagulant, about 2.69 grams aluminum sulfate mixed with about 36 grams deionized water. The slurry was then transferred to a 2 liter Buchi reactor and mixed at about 460 rpm. The slurry was then aggregated at a batch temperature of about 41° C..

During aggregation, a shell including the same amorphous emulsion described above was added and the batch was then further heated to about 41° C. to achieve the targeted particle size.

Once at the target particle size, the pH was adjusted using sodium hydroxide (NaOH), ethylene diamine tetraacetic acid (EDTA), and then again with sodium hydroxide, to freeze, i.e., stop, the aggregation. The process proceeded with the reactor temperature (Tr) being increased to about 70° C. Once at the desired temperature, the pH was adjusted to about 7.1 using sodium acetate buffer where the particles began to coalesce. After about three and a half hours, particles had a circularity >0.962 and were cooled by lowering the reactor temperature.

The resulting toner had a particle size of about 6.3 microns, a Volume Average Geometric Size Distribution (GSDv) of about 1.25, a Number Average Geometric Size Distribution (GSDn) of about 1.27, and a circularity of about 0.975.

The charging/blocking and fusing of the toner particles of Example 10 were evaluated. The charging and blocking were found to be similar to a control toner (a DOCUCOLOR 700 cyan toner, commercially available from XEROX Corp.).

Initial fusing evaluation was carried out using a XEROX DOCUCOLOR 700 fusing fixture. Standard operating procedures were followed where unfused images of the toner of Example 10, and a control toner (a DOCUCOLOR 700 cyan toner, commercially available from XEROX Corp.), were developed onto DCX+ 90 gsm paper and DCEG 120 gsm paper (both commercially available from XEROX Corp.). The toner mass per unit area for the unfused images was about 0.5 mg/cm². Both the control toner as well as the test toner were fused over a wide range of temperatures. Cold offset, gloss, crease fix, and document offset performance were measured.

The toner of Example 10 possessed similar print characteristics including gloss, crease, hot-offset, and document offset performance, as compared with the control toner.

A cyan toner was thus successfully prepared with no noticeable differences in aggregation/coalescence behavior, and with fusing and charging performance equivalent to the toner using conventional petroleum based solvents.

Emulsions made from these bio-based solvents also demonstrated non-degradation of the resin, and EA ULM toners were made with similar particle size, geometric size distribution (GSD) and morphology, compared with toners produced with petroleum based solvents.

It will be appreciated that variations of the above-disclosed and other features and functions, or alternatives thereof, may be desirably combined into many other different systems or applications. Also that various presently unforeseen or unanticipated alternatives, modifications, variations or improvements therein may be subsequently made by those skilled in the art which are also intended to be encompassed by the following claims. Unless specifically recited in a claim, steps or components of claims should not be implied or imported from the specification or any other claims as to any particular order, number, position, size, shape, angle, color, or material.

What is claimed is:

1. A process comprising:
contacting at least one polyester resin with at least one bio-based solvent to form a resin mixture;
stirring the resin mixture;
contacting the mixture with a neutralizing agent to form a neutralized mixture;
contacting the neutralized mixture with de-ionized water to form an emulsion; and
recovering the emulsion.

2. A process according to claim 1, wherein the at least one bio-based solvent is selected from the group consisting of 2-methyl-tetrahydrofuran, ethanol, 1,2-propane-diol, 1,3-propane-diol, 1,4-butane-diol, furfuryl alcohol, 2-butyl furan, difurylpropane, ethyl furfuryl ether, 2-bromo furan, 2-butyryl furan, 20-ethyl furan, 2-furaldehyde, 2-furfuryl alcohol, 2-methyl furan, tetrahydrofurfuryl alcohol, 2,5 dimethylfuran, and combinations thereof, and wherein the bio-based solvent is present in an amount from about 1 weight percent to about 200 weight percent of the resin.

3. A process according to claim 1, wherein the bio-based solvent comprises 2-methyl-tetrahydrofuran and ethanol.

4. A process according to claim 1, wherein the neutralized mixture has a pH from about 8 to about 14.

5. A process according to claim 1, wherein the latex has a solids content from about 5% to about 50%, and a particle size from about 10 nm to about 500 nm.

6. A process according to claim 1, further comprising heating the resin mixture to a temperature of from about 40° C. to about 90° C.

7. A process according to claim 1, wherein recovering the emulsion further comprises removing a water/solvent distillate from the emulsion.

8. A process according to claim 7, further comprising separating the solvent from the water/solvent distillate, and re-using the solvent.

9. A process comprising:
contacting at least one amorphous polyester resin and an optional crystalline resin with at least one bio-based solvent to form a resin mixture;
heating the resin mixture to a temperature of from about 40° C. to about 90° C.;
stirring the resin mixture;
contacting the mixture with a neutralizing agent to form a neutralized mixture;
contacting the neutralized mixture with de-ionized water to form an emulsion;
distilling off a water/solvent distillate from the emulsion; and
recovering the emulsion.

10. A process according to claim 9, further comprising separating the bio-based solvent from the water/solvent distillate, and re-using the solvent.

11. A process according to claim 9, wherein the at least one bio-based solvent is selected from the group consisting of 2-methyl-tetrahydrofuran, ethanol, 1,2-propane-diol, 1,3-propane-diol, 1,4-butane-diol, furfuryl alcohol, 2-butyl furan, difurylpropane, ethyl furfuryl ether, 2-bromo furan, 2-butyryl furan, 20-ethyl furan, 2-furaldehyde, 2-furfuryl alcohol, 2-methyl furan, tetrahydrofurfuryl alcohol, 2,5 dimethylfuran, and combinations thereof, and wherein the bio-based solvent is present in an amount from about 1 weight percent to about 200 weight percent of the resin.

12. A process according to claim 9, wherein the bio-based solvent comprises 2-methyl-tetrahydrofuran and ethanol.

13. A process according to claim 9, wherein the neutralized mixture has a pH from about 8 to about 14.

14. A process according to claim 9, wherein the amorphous polyester resin comprises alkoxylated bisphenol A fumarate/terephthalate based polyesters and copolyester resins present in an amount from about 60 percent by weight to about 95 percent by weight of the toner particles.

15. A process according to claim 9, wherein the optional crystalline resin comprises a crystalline polyester resin including acidic groups with an acid number from about 5 to about 50 mg KOH/g polymer present in an amount from about 1 percent by weight to about 85 percent by weight of the toner particles.

16. A process according to claim 9, wherein the latex has a solids content from about 5% to about 50%, and wherein the latex particles have a particle size from about 10 nm to about 500 nm.

17. A process according to claim 9, further comprising contacting the latex particles with a colorant and an optional wax to form toner particles.

18. A process comprising:
contacting at least one amorphous resin with at least one bio-based solvent selected from the group consisting of 2-methyl-tetrahydrofuran, ethanol, 1,2-propane-diol, 1,3-propane-diol, 1,4-butane-diol, furfuryl alcohol, 2-butyl furan, difurylpropane, ethyl furfuryl ether, 2-bromo furan, 2-butyryl furan, 20-ethyl furan, 2-furaldehyde, 2-furfuryl alcohol, 2-methyl furan, tetrahydrofurfuryl alcohol, 2,5 dimethylfuran, and combinations thereof, to form a resin mixture;
heating the resin mixture to a temperature of from about 40° C. to about 90° C.;
stirring the resin mixture;
contacting the mixture with a neutralizing agent to form a neutralized mixture;
contacting the neutralized mixture with de-ionized water to form an emulsion;
removing a water/solvent distillate from the emulsion;
recovering the emulsion; and
contacting the emulsion with a colorant, an optional wax, and a crystalline polyester resin to form toner particles.

19. A process according to claim 18, wherein the bio-based solvent is present in an amount from about 1 weight percent to about 200 weight percent of the resin, and further comprising separating the bio-based solvent from the water/solvent distillate, and re-using the solvent.

20. A process according to claim 18, wherein the amorphous polyester resin comprises alkoxylated bisphenol A fumarate/terephthalate based polyesters and copolyester resins present in an amount from about 60 percent by weight to about 95 percent by weight of the toner particles, and wherein the crystalline polyester resin has acidic groups and an acid number from about 5 to about 50 mg KOH/g polymer, and is present in an amount from about 1 percent by weight to about 85 percent by weight of the toner particles.
